(19) United States
(12) Patent Application Publication
(10) Pub. No.: US 2009/0074256 A1
(43) Pub. Date: Mar. 19, 2009

(54) Apparatus and methods for testing biometric equipment

(75) Inventor: Waleed S. Haddad, San Francisco, CA (US)

Correspondence Address: PEPPER HAMILTON LLP, ONE MELLON CENTER, 50TH FLOOR, 500 GRANT STREET, PITTSBURGH, PA, 15219, US

(73) Assignee: Solidus Networks, Inc., San Francisco, CA (US)

(21) Appl. No.: 12/074,569

(22) Filed: Mar. 5, 2008

Related U.S. Application Data
(60) Provisional application No. 60/892,960, filed on Mar. 5, 2007.

(51) Int. Cl. G06K 9/00; B29C 43/02

(52) U.S. Cl. 382/115; 264/104

(57) ABSTRACT

This invention encompasses an apparatus and methods which enable the testing of fingerprint readers in an automated fashion. A test object representative of a fingerprint can be created from an electrically conducive silicone material. Due to the properties of this material, the same test object can be read by fingerprint sensors of various types. Once the test object is generated, it can be affixed to an automated apparatus thus allowing tests to be conducted in closed chambers, on an assembly line, or under other conditions that would be impossible or impractical were human fingers to be used.

### CROSS-REFERENCE TO RELATED APPLICATIONS

This application claims priority benefit under 35 U.S.C. §119(e) from Provisional Patent Application Ser. No. 60/892,960, filed Mar. 5, 2007.

### GOVERNMENT INTERESTS

Not applicable

### PARTIED TO A JOINT RESEARCH AGREEMENT

Not applicable

### INCORPORATION BY REFERENCE OF MATERIAL SUBMITTED ON A COMPACT DISC

Not applicable

### BACKGROUND

The use of biometric data has greatly increased in recent years, and, as such, there is a demand for accurate and reliable biometric input devices, such as fingerprint readers. Before an organization, such as a private company or government institution, selects a biometric input device for its needs, it may first wish to perform a comparative analysis of various devices to see which meets its requirements. The organization could perform this analysis itself or could hire a consulting firm to accomplish this task. While each organization or firm may have its own testing methods, such methods are typically inefficient, costly, or both.

For example, the testing of fingerprint readers can be problematic because the requirements of such testing inhibit effective and economical procedures. To ensure accuracy and consistency, environmental testing should be conducted in sealed chambers or in places with limited human access. However, because the purpose of a biometric input device is to obtain a sample of a human characteristic (e.g., a fingerprint), some form of human access is typically needed. Furthermore, testing during production, such as on an assembly line, needs to be automated, rapid, repetitive, and highly controlled, and current testing methods do not facilitate such demands. For instance, testing fingerprint readers with live biometric samples is inappropriate for production. Scientific testing requires a well-defined and consistent test object to serve as a common input in order to evaluate accurately the properties of one or more fingerprint readers. A live biometric sample may not be sufficient due to the nature of biometrics. Although the same human can provide the same sample to various devices, it is unlikely that the data acquired from the sample will be consistent. For example, particular ridges, whorls, and minutiae, or other biometric features obtained from a person upon one read may not be the same ones obtained on a second read due to the positioning of the person's finger on the sensor.

Numerous companies and test laboratories devise and use artificial fingerprints in order to analyze illicit use of fingerprint readers (known as “spoofing”). Through such analysis, these organizations evaluate how successful a fingerprint reader is in detecting the use of an artificial fingerprint. However, artificial fingerprints are not typically developed as test objects for examining the legitimate performance of fingerprint readers.

Furthermore, in order to test different types of fingerprint readers, a laboratory must be equipped with equipment and materials suitable for each type of reader. Doing so can be costly and, moreover, does not allow for a common test object. For example, in order to test both capacitive and optical fingerprint readers with artificial fingerprints, a laboratory may need to construct the fingerprints from different materials appropriate for each type of reader. Although the same test pattern may be used, the resulting test objects cannot be assured to have the same characteristics as each material may accept the pattern differently or have its own particular variables.

Therefore, what is needed is a process which enables an organization to implement standardized and automated testing of various types of fingerprint readers.

### BRIEF SUMMARY OF THE INVENTION

This invention encompasses an apparatus and methods which enable the testing of fingerprint readers in an automated fashion. A test object representative of a fingerprint can be created from an electrically conducive silicone material. Due to the properties of this material, the same test object can be read by fingerprint sensors of various types. Once the test object is generated, it can be affixed to an automated apparatus thus allowing tests to be conducted in closed chambers, on an assembly line, or under other conditions that would be impossible or impractical were human fingers to be used.

### BRIEF DESCRIPTION OF THE DRAWINGS

FIG. 1 depicts a flowchart of a process for creating a test object that can be employed by the apparatus of the present invention.

FIG. 2 depicts an illustration of an embodiment of a fingerprint reader testing apparatus.

FIG. 3 depicts a flowchart of a process for testing a fingerprint reader with the apparatus of the present invention.

### DETAILED DESCRIPTION OF THE INVENTION

Various embodiments of the invention are discussed in detail below. While specific implementations are discussed, it should be understood that this is done for illustration purposes only. A person with ordinary skill in the relevant art will recognize that other components and configurations can be used without parting from the spirit and scope of the invention.

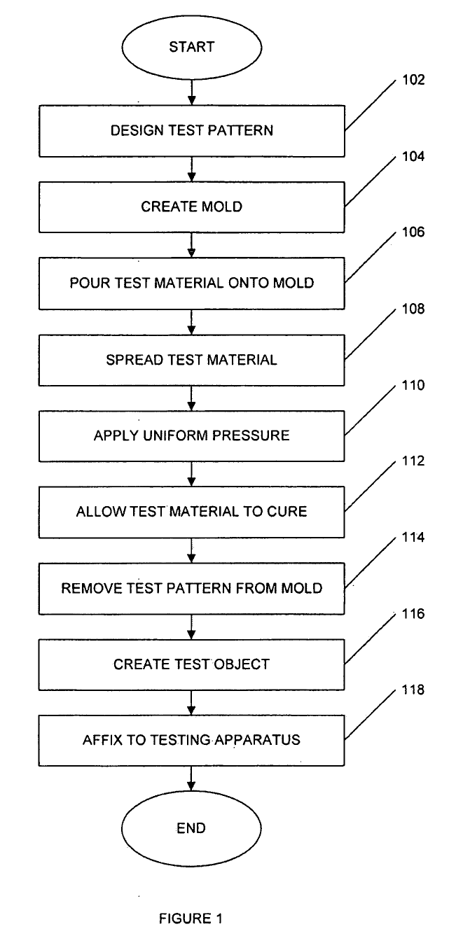

FIG. 1 depicts a flowchart of a process for creating a test object that can be employed by the apparatus of the present invention. A test pattern may be designed (step 102) for testing resolution, contrast, distortion, and other properties. The designer of the pattern can control the variance in different areas of the resulting image in order to represent a certain statistical distribution (e.g., grayscale, pressure, presence of key features, etc.). The test pattern can be a copy of a real fingerprint or a design that mimics an actual fingerprint. For example, the testing organization could collect actual fingerprints and such fingerprints could be deliberately distorted in order to achieve a desired variance. The test pattern could be generated manually or by use of an automated procedure. For example, an individual could employ a computer program to select desired fingerprint features from a matrix to generate the appropriate test pattern. Fingerprint simulator software applications are also available, and could be used to generate fingerprint patterns, including typical features found in human prints, as well as forms of distortion that commonly occur during use of fingerprint readers.

Once the test pattern has been designed, it is applied to material to create a mold (step 104). In one embodiment, the mold is a created from a large sheet of plastic scored to the particulars of the test pattern. Typically, a mold is designed to have the negative of the desired pattern. Particular plastics, such as Polypropylene, Polyethylene, or Polytetrafluoroethylene, can be used to construct the mold because the silicone test material typically does not adhere to these substances. The mold could also be created from other materials, such as metals or other plastics, however such molds must typically be pre-coated with a release agent (such as a light oil or wax) so that the resulting test pattern can be removed without substantial damage to fine features of the replicated pattern. The use of a mold to produce these test objects is advantageous because it can be reused to replicate copies of the same pattern many times. This is useful in cases, such as in production testing, when multiple devices must be tested simultaneously using identical test objects.

Once the mold has been created with the desired test pattern, the test material is poured onto its surface (step 106). Preferably, the test material is a conductive silicone substance, as this substance can produce test patterns useable by fingerprint readers of various types, such as optical, capacitive, pyroelectric (thermal), ultrasonic, non-contact, multispectral, and the like. Furthermore, the test patterns could be useable by fingerprints readers equipped with or without platen sensors or with swipe sensors. If a fingerprint reader has a spoof detection feature, this function could be disabled for testing if necessary. In one embodiment, the test object material is an electrically conductive bonding and gasketing silicone adhesive, such as Loctite 5421 produced by Henkel Technologies. Test patterns made from this material are stable and functional at high and low temperatures. For example, such test patterns have been used in tests conditions ranging from −30 degrees Centigrade to +70 degrees Centigrade. Such material (e.g., Loctite 5421) is readily available from retail outlets, such as industrial supply companies.

For example, the test material can be spread into the impressions of the mold by covering the material and working it outwards from the center (step 108). Once the material has been poured onto the mold, a large sheet of paper (or other suitable backing material) could be placed across it. Pressure could be applied to the covering by hand or by a mechanical compress, thereby forcing the test material into the impressions of the mold. Once the material has been adequately spread, uniform pressure can be applied by placing a weight on top of the covering (step 110). For example, a weight could be manually applied or a compression mechanism could hold the covering in place. The test material is then allowed to cure (step 112). Once cured, the material can be removed from the mold (step 114), typically as a single piece of test pattern material. Test objects can then be created from the test pattern material (step 116). For example, the test pattern material can be cut into circular disks. To allow the test object to be flexible, and therefore representative of an actual finger, a flexible backing, such as neoprene foam, can be affixed to the back (un-patterned side) of the test pattern (e.g., via a commercial silicone adhesive). Once the test object has been created, it can be affixed to the testing apparatus, as described in further detail below (step 118). As multiple test objects from the same test pattern can be created, variability can be eliminated from testing and a user can employ the test objects as a common input to accurately isolate problems with various fingerprint readers.

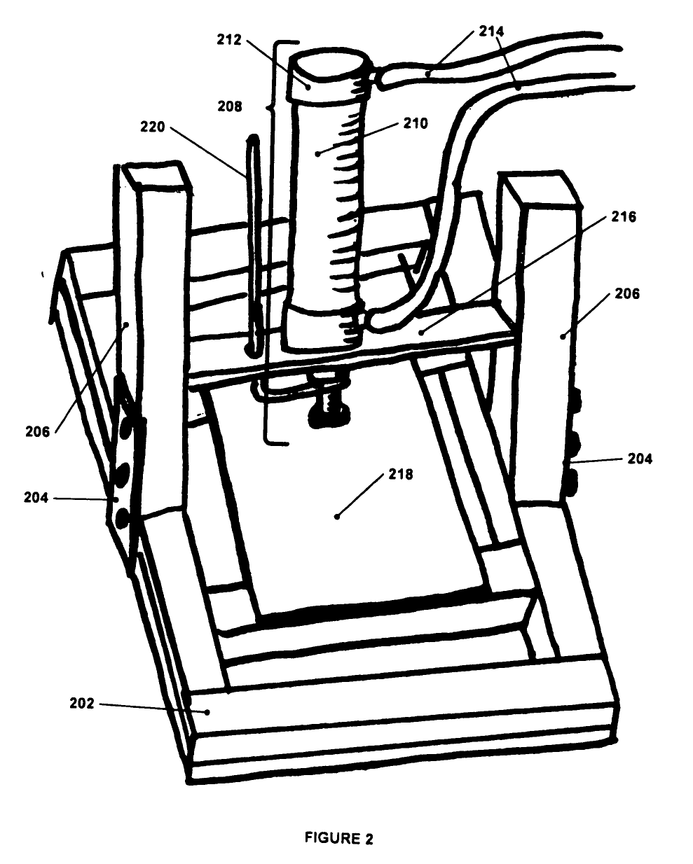

FIG. 2 is an illustration of an embodiment of a fingerprint reader testing apparatus. The apparatus's support frame can include a base 202 constructed from t-slotted aluminum framing. Likewise, t-slotted aluminum framing can be used to construct the actuator supports 206. Two pivot brackets 204 can affix the actuator supports 206 to the base 202. The use of the pivot brackets 204 allows a user to adjust the angle of actuator 208 per the needs of the fingerprint reader being tested or per the parameters of a particular test. A flat, aluminum bar 216 can be attached to the interiors of the actuator supports 206, thereby connecting them and ensuring that they pivot in tandem. The aluminum bar 216 can have a hole at its center to allow the actuator 208 to be attached to the support frame. The air cylinder 210 of the actuator 208 can be attached to the support frame by positioning the rod of the air cylinder 210 through the hole in the aluminum bar 216 and then securing it into place. Airline fittings 212 can be affixed to the air cylinder 210 to enable the transfer of air via attached nylon airlines 214. The air pressure in the air cylinder 210 can be regulated by a pressure regulator, and thereby enable the air cylinder 210 to apply the test object onto the fingerprint reader with the desired pressure. In-line speed controls can be used with an air delivery system to control the speed at which the air cylinder 210 moves so that the force is applied gradually to the test objects. In one embodiment, the apparatus could include a mechanism, such as a weight or lever arm, to apply the test object to the fingerprint reader with consistent pressure. Such a mechanism could be particularly useful for desktop or laboratory testing. A small platform 218 constructed of metal or plastic can be affixed to the support frame, beneath the actuator 208, and can be used to support a fingerprint reader. In addition, the platform 218 could have registration features which allow repeatable, accurate positioning of fingerprint readers into the test apparatus. The platform 218 could also be designed to accommodate different fingerprint readers, making it a universal test apparatus.

As mentioned, the pivot brackets 204 facilitate easy adjustment of the angle of the actuator 208. Additionally, the use of t-slotted aluminum framing allows a user to adjust the height of the actuator 208 on the actuator supports 206. The apparatus could include additional mechanisms to allow even greater precision. For example, an orientation mechanism 220 could be a wire attached to the rod of the air cylinder 210. The orientation mechanism 220 could enable manipulation of the test object prior to or during testing. Furthermore, an orientation mechanism 220 could ensure that the test object maintains the desired position throughout the testing procedure. For example, if the orientation mechanism 220 is a wire attached to the rod of the air cylinder 210, it could be fed through a hole in the aluminum bar securing the actuator supports 206. This orientation mechanism 220 could restrict the movement of the test object on the rod (e.g., prevent it from rotating) as the air cylinder 210 lowers it onto a fingerprint reader. These features enable the apparatus to be adaptable and, thus, accommodate a range of fingerprint readers. Although the apparatus described has been configured for platen sensors, modifications could be made to enable the testing of swipe sensors or sensors without platen covers.

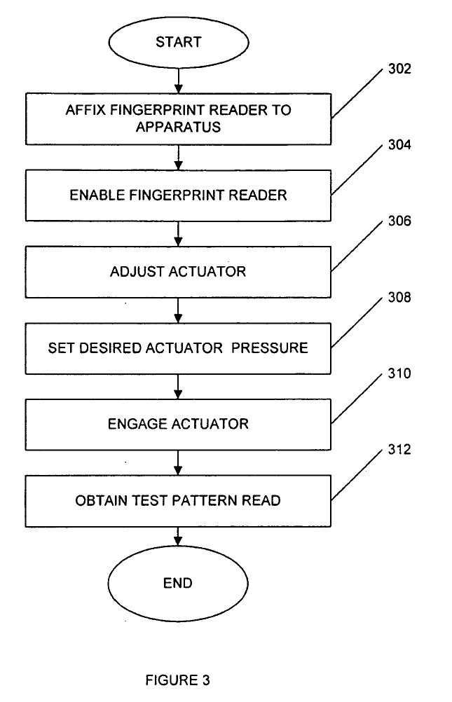

FIG. 3 depicts a flowchart of a process for using the apparatus to test a fingerprint reader. Once the test object has been created, it can be affixed to a metal plate and attached to the rod of the air cylinder 210. The user can position the fingerprint reader to be tested upon the platform 218 of the apparatus (step 302). If desired, mounting screws, a clamping mechanism, a temporary adhesive or a mechanism or technique of similar functionality or effectiveness could be used to secure the fingerprint reader into place. The fingerprint reader can then be enabled for testing, such as by connecting it to a power source (step 304). The user can adjust the actuator 208 to the desired orientation, such as by adjusting the angle of the air cylinder 210 via the pivot brackets 204 or adjusting the test object's position via the orientation mechanism 220 (step 306), The user can also select the pressure to be provided to the air cylinder 210 (step 308) and then engage the actuator 208 (step 310) by means of a valve. This valve may be controlled manually, or by computer control, thereby allowing automation of the testing. Pressurized air is routed into the air cylinder 210 via the nylon airlines 212 and the rod of the air cylinder 210 lowers and presses the test object against the sensor of the fingerprint reader. The fingerprint reader can then read the test pattern and generate an image (step 312).

The process depicted in FIG. 3 can be applied to one or more units of the described apparatus. The use of airflow controls allows the actuators 208 of multiple units to operate in parallel with each applying identical pressure or varying pressure with a controlled distribution, depending on the test objectives. Furthermore, as the test object utilized can be employed for testing various types of fingerprint readers, a variety of readers could be tested simultaneously under the same conditions.

Additionally, the present invention allows for the testing in a highly controlled environment. An individual can test biometric input devices in a secure environment without human interference, and, therefore, be assured of a high level of consistency. Furthermore, due to the construction of the apparatus, a wide range of environmental conditions can be employed during testing. For example, air cylinders 210 operate reliably in harsh conditions over a wide temperature range, and are not highly susceptible to humidity. Therefore, an individual can evaluate the performance of one or more fingerprint readers in various environmental scenarios. Additionally, air cylinders 210 do not emit, nor are they susceptible to, electrical and radio frequency noise, and therefore are not likely to interfere with the performance of a fingerprint reader.

As the apparatus of the present invention enables testing fingerprint readers without direct human contact, tests can be conducted in closed chambers, on an assembly line, or under conditions that would otherwise not be possible. Due to the consistency of the test objects used and the automation of the testing procedure, an organization can use the apparatus and methods described herein to standardize and automate its testing procedures.

Terminology used in the foregoing description is for the purpose of describing the particular versions or embodiments only, and is not intended to limit the scope of the present invention which will be limited only by the appended claims. As used herein and in the appended claims, the singular forms “a,” “an,” and “the” include plural references unless the context clearly dictates otherwise. Similarly, the words “for example”, “such as”, “include,” “includes” and “including” when used herein shall be deemed in each case to be followed by the words “without limitation.” Unless defined otherwise herein, all technical and scientific terms used herein have the same meanings as commonly understood by one of ordinary skill in the art. Nothing herein is to be construed as an admission that the embodiments disclosed herein are not entitled to antedate such disclosure by virtue of prior invention. Thus, various modifications, additions and substitutions and the like can be made without departing from the spirit of the invention and these are therefore considered to be within the scope of the invention.

1. A method for creating an object to be employed for testing one or more biometric input devices, the method comprising:
designing a pattern representative of a biometric;
creating a mold based upon of the designed pattern;
applying a conductive silicone material to the mold;
applying pressure to the conductive silicone material;
allowing the conductive silicone material to cure in the mold;
removing the cured conductive silicone material from the mold; and
portioning the cured conductive silicone material into one or more objects.

2. The method of claim 1, wherein an object produced from the conductive silicone material can be interpreted by more than one type of biometric input device associated with the same kind of biometric.

3. An apparatus for testing a biometric input device using a simulated biometric test object, the apparatus comprising:
a support frame, further having:
a base;
one or more actuator supports; and
a platform, wherein the platform can hold a biometric input device;
an actuator, further having:
an air cylinder; and
one or more airline fittings, wherein the actuator is configured to supply air in manner effective to apply the test object onto the biometric input device at a desired pressure.

4. The apparatus of claim 3, wherein the actuator is affixed to the support frame in a manner enabling adjustment of the positioning of the actuator.

5. The apparatus of claim 3, further comprising a mechanism capable of orientating a test object attached to the actuator.

6. The apparatus of claim 3, further comprising a mechanism to channel air to the air cylinder via an airline.

7. A method for testing a biometric input device, the method comprising;
affixing a biometric input device to a testing apparatus;
enabling the biometric input device for functionality;
engaging the testing apparatus, wherein said engaging comprises prompting an actuator to apply a test object to the input area of the biometric input device; and
obtaining output from the biometric input device based upon the test object.

8. The method of claim 7, further comprising adjusting the testing apparatus to accommodate the biometric input device.

9. The method of claim 7, further comprising adjusting the testing apparatus per one or more test parameters.
